(19) United States
(12) Patent Application Publication
(10) Pub. No.: US 2015/0053093 A1
(43) Pub. Date: Feb. 26, 2015

(54) Combination Counter Top Toaster and Food Warmer

(71) Applicant: Peter Chung-Yuan Chang, San Diego, CA (US)

(72) Inventor: Peter Chung-Yuan Chang, San Diego, CA (US)

(21) Appl. No.: 14/465,673

(22) Filed: Aug. 21, 2014

Related U.S. Application Data
(60) Provisional application No. 61/868,327, filed on Aug. 21, 2013.

(51) Int. Cl. A47J 37/08

(52) U.S. Cl. CPC A47J 37/0871; A47J 37/08
USPC 99/341; 99/373

(57) ABSTRACT

A toasting appliance is provided having a housing with a small footprint and having a toasting cavity for toasting bread and a horizontally disposed cooking cavity for cooking food. One or more doors in a side of the housing provide access to the cooking cavity and viewing windows to view both cooking food in the cooking cavity or toasting bread in the toasting cavity.

This application claims priority to U.S. Provisional Patent Application Ser. No. 61/868,327 filed on Aug. 21, 2013, which is incorporated herein in its entirety by this reference thereto.

### FIELD OF THE INVENTION

The disclosed device relates to toasters used in kitchens in homes and other venues. More particularly, it relates to an improved counter top bread toaster, which in the same counter top footprint as the toaster, also includes a baking and warming cavity accessible in a second heating cavity of the toaster.

### BACKGROUND OF THE INVENTION

The device and method herein described and disclosed, relate to counter top bread cooking devices such as toasters which have evolved little since their origin in the early part of the century. Most such devices simply toast bread and bread products in vertical slots. However, for many users, the counter top space occupied by a toaster is large, considering that it is usable only to toast bread, or a bagel, usually for breakfast. Consequently, the appliance stays dormant during most of its time situated on the kitchen or other counter.

Many such users lack counter space for a plurality of appliances, and therefor must choose between devices such as a microwave, a toaster, and a food warmer. A toaster and its vertically disposed slots for toasting bread, which renders the small footprint for the toaster, is unable to safely cook bread, or warm pizza or restaurant leftovers or other products because the toppings or juices will run off vertically disposed bread in the conventional toaster and can start a small fire. Counter top ovens capable of such cooking have a large footprint on the counter top and do not toast bread without toppings very quickly, efficiently, or evenly, and not only waste counter space, but also energy.

As such, there exists an unmet need for a counter top toaster which employs a cavity adapted for close heating of vertically disposed bread, bagels and the like, quickly and efficiently and which also provides a secondary heating cavity configured for the horizontal heating of covered bread products, meats, vegetables and restaurant and home meal leftovers. Such a device should occupy a small footprint on a countertop like a toaster, yet concurrently provide a means to evenly and quickly toast bread alone, and to re-warm or toast bread, pizza, and food-covered products and the like, in a horizontal position, to prevent running of the toppings. Such a device should prevent the user from cooking with both sections at once lest it overpower the electrical circuit. Such a device should operate in the same fashion as conventional toasters and provide means for collection of crumbs which will prevent the crumbs from entering the horizontal cooking cavity. Finally, such a device should provide easy access to the horizontally disposed cavity through one or both sides of the toaster, for horizontal tray placement.

In this respect, before explaining at least one embodiment of the small footprint combined vertically disposed toaster and horizontally disposed warming cavity, herein in detail, it is to be understood that the invention is not limited in its application to the details of construction and to the arrangement of the components set forth in the following description or illustrated in the drawings nor the steps outlined in the specification. The disclosed small-footprint appliance which includes a vertically disposed toaster cavity, as well as a separate horizontally disposed oven cavity, is capable of other embodiments and of being practiced and carried out in various ways as those skilled in the art will readily ascertain, once educated in the novel device and method of operation disclosed in this application.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes of the automatic temperature switching cooker disclosed herein. It is important, therefore, that the claims be regarded as including such equivalent construction insofar as they do not depart from the spirit and scope of the present invention.

### OBJECTS OF THE INVENTION

An object of this invention is the provision of a counter top electric cooking device, which toasts bread and bagels in a conventional vertical disposition in a first cavity, and provides a second horizontally disposed cavity for baking and which reheats food in a horizontal disposition, in a counter top footprint substantially the same as a toaster alone.

It is an additional object to provide such an appliance wherein the toaster operates substantially like a conventional toaster to minimize the learning curve to use the appliance.

It is a further object of the invention to provide such an appliance which provides the user access to the separated baking cavity from both sides of the appliance to give the user the ability of easy insertion, removal, and adjusting or seasoning of the food being heated.

These together with other objects and advantages of the disclosed counter top toaster and warming oven herein which will become subsequently apparent to those skilled in the art, reside in the details of the construction and method herein as more fully hereinafter described and claimed, reference being had to the accompanying drawings forming a part thereof, wherein like numerals refer to like parts throughout.

### SUMMARY OF THE INVENTION

As depicted in the drawings and described in the specification, the disclosed device provides a toaster with conventional vertical toasting slots in a toasting cavity, proximate to a heating element to provide fast toasting with minimal energy use. The device has a housing which provides a small footprint device adapted for counter top use and situating. Additionally provided in this small footprint, within the housing, is a second horizontally disposed heating cavity or oven. The heating cavity may be accessed in one mode of the device by a translating drawer in the base of the housing, and in another particularly preferred mode, through rotationally engaged pivoting doors on opposing sides of the housing. The opposing doors provide a particularly good access to the heating cavity for insertion and removal of food, and for seasoning all areas of any food being heated. Thus bread may be toasted in the toasting cavity formed in the housing or the user may employ the heating cavity by insertion through either of two doors of items to heat such as a pizza slice or melted cheese sandwich, or restaurant or dinner leftovers.

Additionally, provided in one mode is a novel peaked crumb catching component which doubles as a focusing lens for heat generated by a heating element situated in the warming cavity. Crumbs landing on the upper surface from the bread toaster, are diverted over the drawer and heating cavity to collection points on the sides of the toaster. The two planar sections of the diverting component act to reflect and to focus heat from a heating component, toward the bread or pizza or other food, located in the bottom of the warming cavity. A drawer provides means for access to the warming cavity and for insertion and removal of food.

In another mode of the device, the crumb catching component is translatably engageable though a sidewall of the housing, and forms a portion of the separation between the toasting cavity and the heating cavity at the lower end of the housing.

Also included preferably in all modes of the device are a safety circuit to prevent any over-current situation where the device might draw too much current from a circuit. The passive circuitry, using a solid state or other switching component, only allows current to flow to one of the toasting cavity or the heating cavity.

In the mode of the device having opposing doors formed in opposing sides of the housing providing access to the heating cavity from two sides, at least one of the doors preferably has a glass wall therein. This glass wall provides the user a view of the toasting bread in the toasting cavity to ascertain the degree of toasting which has occurred during use.

With respect to the above description then, it is to be realized that the dimensional and electronic relationships for the parts of the invention, may also include variations in size, materials, shape, form, function and manner of operation, manner of formation, assembly and use, which are deemed readily apparent and obvious to one skilled in the art. Therefore, the foregoing summary and following description are considered as illustrative only of the principles of the invention to provide a combination toaster and warming oven or cavity in a counter top device. Further, since numerous modifications and changes will readily occur to those skilled in the art, it is not desired to limit the invention to the exact construction and operation and steps of formation shown and described, and accordingly, all suitable modifications and equivalents may be resorted to, falling within the scope of the invention.

### BRIEF DESCRIPTION OF THE DRAWINGS

FIG. 1 depicts a perspective view of one mode of the appliance having a toasting cavity and warming cavity.

FIG. 2 depicts a translating drawer providing access to the warming cavity positioned below the vertically disposed toasting cavity.

FIG. 3 depicts a cutaway perspective view showing the vertical toasting slots within a toasting cavity and horizontal warming cavity and planar divider having inclined mating planar sections.

FIG. 4 shows a slice view through FIG. 1 depicting the vertical cavities for bread toasting, and horizontal warming cavity, and electrical circuit to allow operation of one or the other of the two sections in all modes of the device.

FIG. 5 depicts another mode of the device where the tray has open side edges for easy food removal and placement of food thereon, and showing a rear-exiting crumb tray.

FIG. 6 shows the device in the mode of FIG. 5 in cut-away showing the crumb tray providing separation between the two cooking chambers as employed in all modes herein.

FIG. 7 depicts a particularly preferred mode of the device herein having both a toasting cavity and warming cavity and providing doors on both sides of the housing to access the warming cavity from either side.

FIG. 8 depicts the mode of the device of FIG. 7 having the doors closed and bread products within the toasting slot adapted to descend into the toasting cavity within the housing.

FIG. 9 depicts the device of FIG. 8 showing the viewing aperture for bread cooking in the toasting cavity provided by glass forming a portion of the doors.

FIG. 10 is a sectional view of the device of FIGS. 7-9 showing the toasting cavity separated from the warming cavity within the housing and the quartz or other heating elements.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only. Consequently they are not intended to be limiting or to imply that the device has to be used or positioned in any particular orientation. The various components of the device disclosed herein can be formed of conventional materials such as aluminum, ceramic, stainless steel, plastic or the like which accomplishes the same desired effect or purpose.

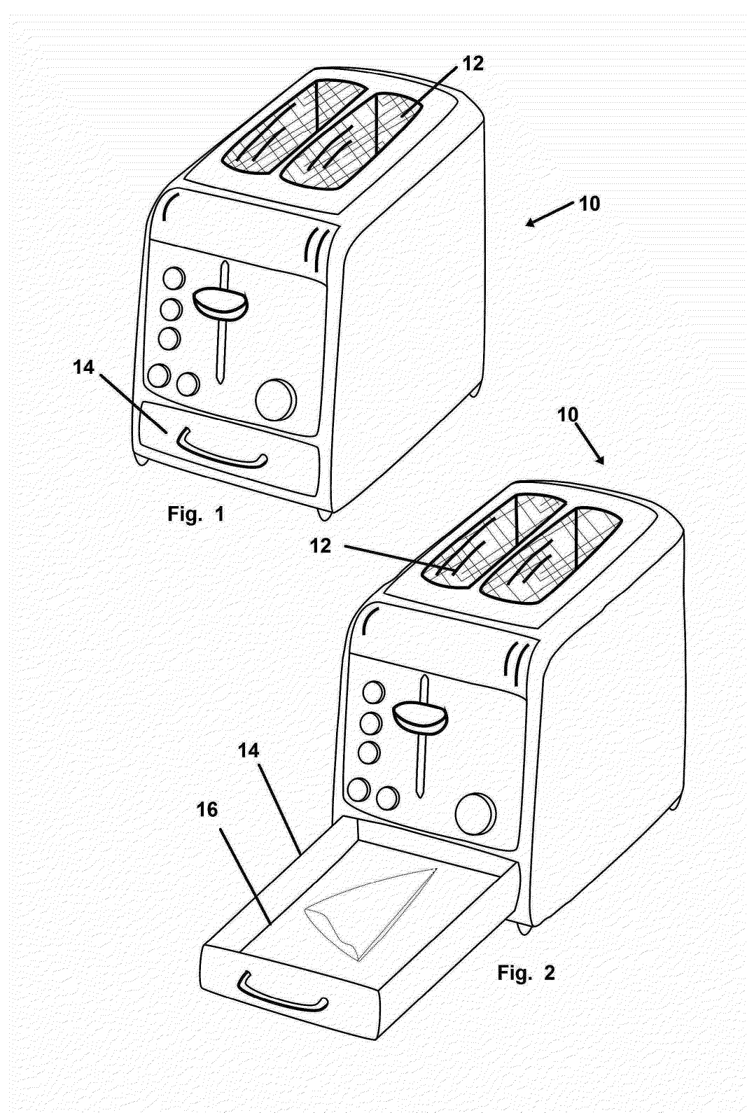

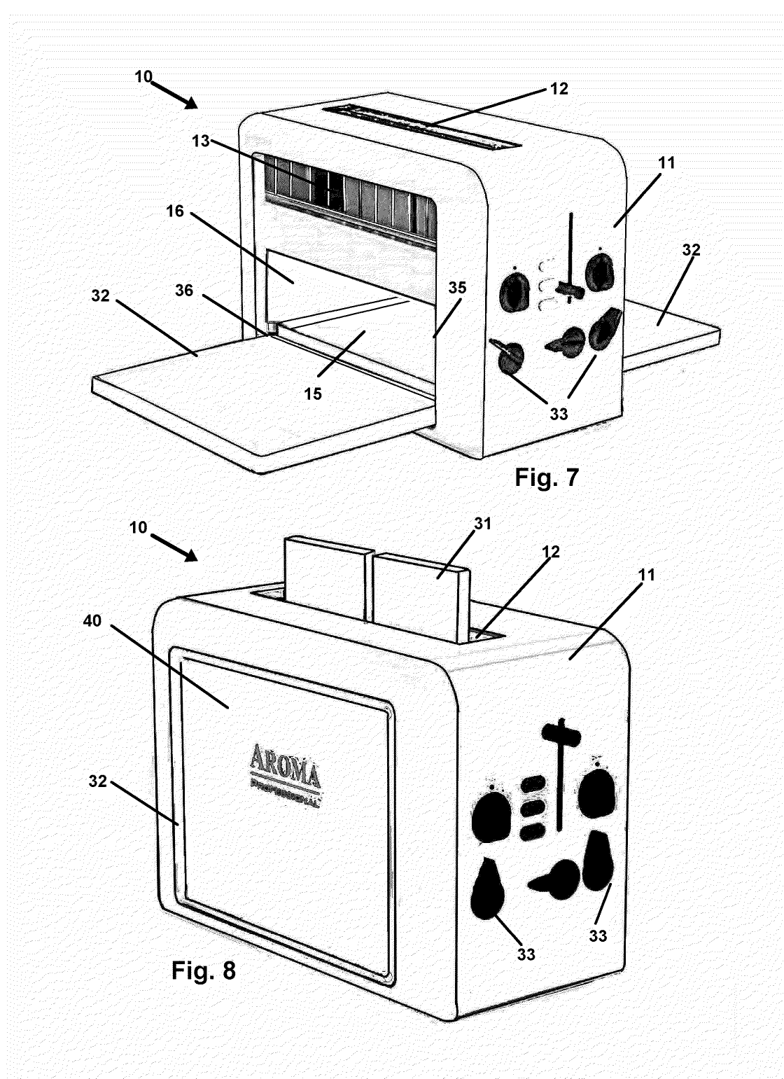

Referring now to the drawings in FIGS. 1-10, wherein similar parts of the appliance device 10 are identified by like reference numerals, the device 10 is provided as a combination countertop toaster with at least one vertically disposed toasting slot 12, and conventional controls therefor, positioned within a toasting cavity 13 of the housing 11. In all modes of the device 10 a horizontally disposed cooking cavity 16 is provided in a lower portion of the housing 11. In the mode of the device 10 of FIGS. 1-6, food is inserted and removed from the cooking cavity 16 using a drawer 14 preferably having open opposing side edges to allow easy sliding removal of food from the surface of the drawer 14. In the mode of the device 10 of FIGS. 7-10, a tray 15 having open sides is shown for placement of food within the cooking cavity 16. The tray 15 as shown which preferably also has opposing open side edges without the sidewall shown on the other side edges defining the perimeter of the tray 15.

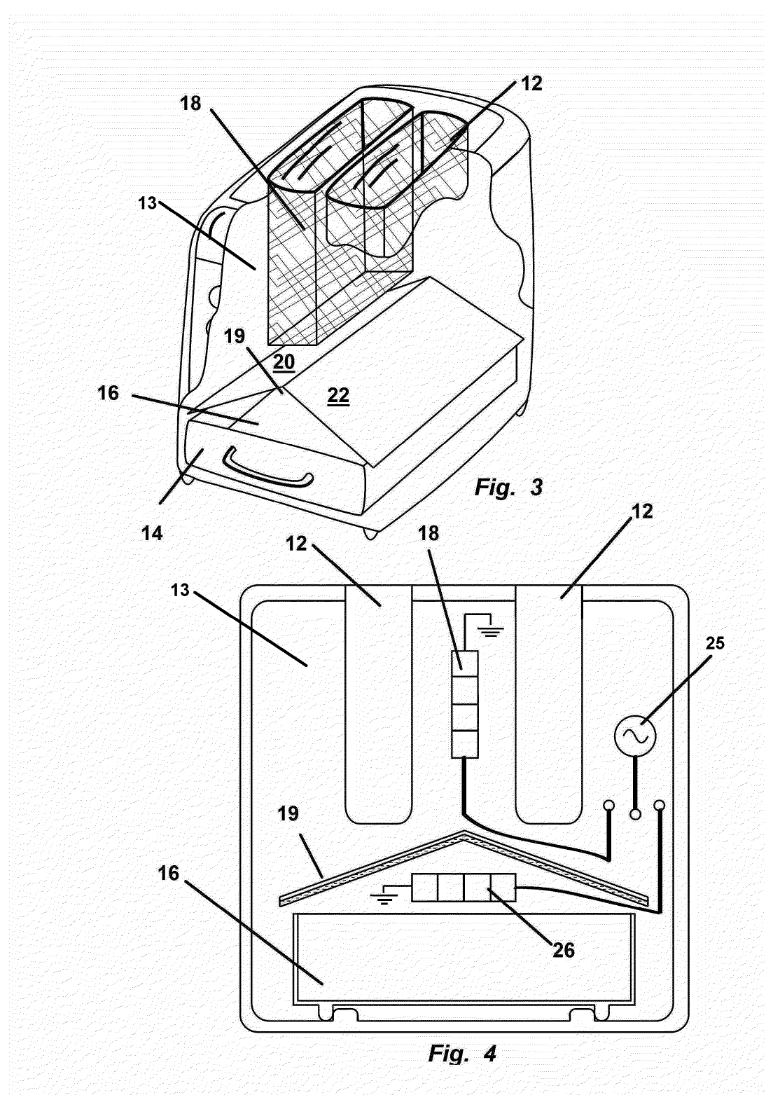

In FIGS. 3-4 can be seen a first set of electrical heating elements 18 which surround the vertical toasting slots 12 in the toasting cavity 13. Also shown in the cut away view is a divider 19 between the toasting cavity 13 and heating cavity 16, formed by two planar sections 20 and 22 which angle to an intersection 24. At least one second heating element 26 is situated on the warming cavity 16 side of the divider 19.

The divider 19 in some figures is shown with slanting halves which provides a means to urge crumbs from bread in the toasting slots 12 to collection positions to the side of the drawer 14 and prevent such from entering the cooking cavity 16. Additionally, the slant of the divider 19 has been shown to provide a lens or means to focus reflected heat from the second heating element 26 toward the bottom surface of the drawer 16 or tray 15 to better heat food therein.

In all modes of the device 10 it is preferred that a protective circuit 25 such as a solid state relay or thermal breaker, be provided. Such is in FIG. 4 and serves to prevent both heating elements 18 and 26, from powering up at the same time, to prevent overheating and to prevent over-current draw from a circuit.

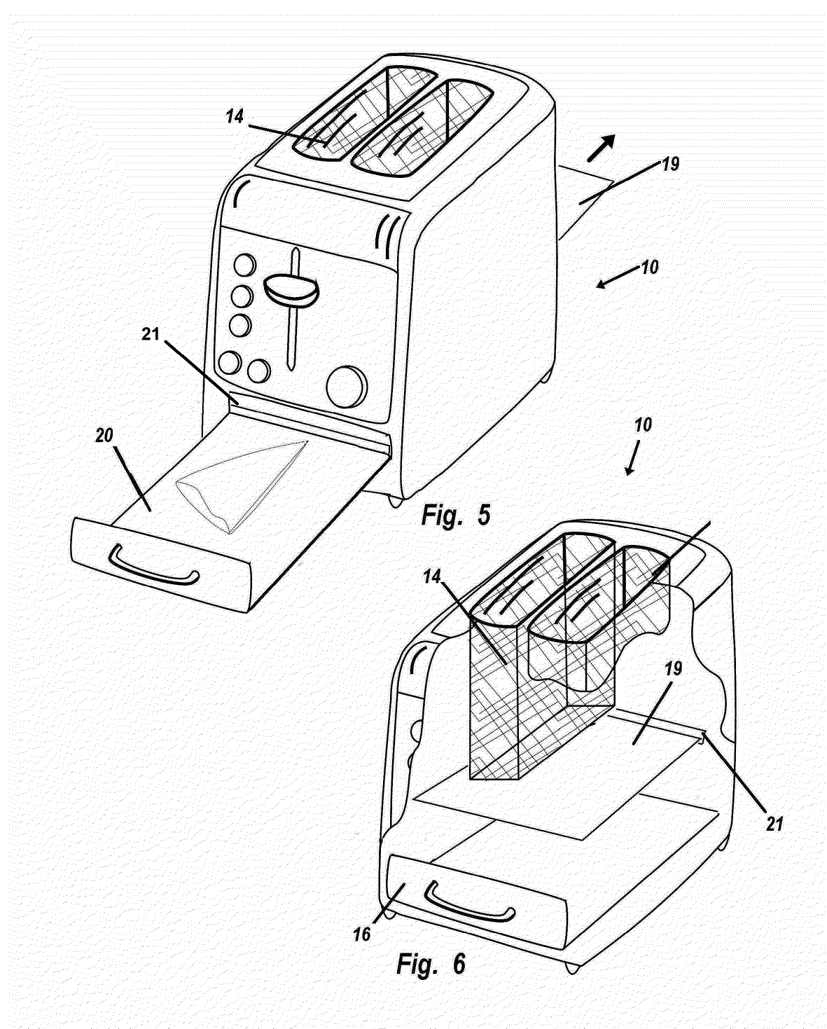

FIG. 5 depicts another mode of the device 10 where the crumb tray 17 providing the divider 18 is substantially planar and positioned to translate through a slot 21 in the rear of the housing 11 of the toaster device 10. The divider 18 might also be similar to that of FIG. 3 and exit through the rear slot 21 also, so long as the slot 21 is in a complimentary shape to the divider 18. The horizontally disposed cooking cavity 16 is accessed by a tray 15 having open side edges which terminate to allow for easy placement and removal of food on the tray 15 surface. The same heating element 26 is positioned above the tray 15 and in the cooking cavity 16 as in the mode of FIG. 3-4. The divider 18 also provides a reflective means for heat from the heating element 26 to reflect back toward food on the tray 15 to enhance cooking.

It should be noted that in all modes of the device 10 herein depicted, the means for translating the bread or other food within the slot 12 or slots, is not depicted to allow a clearer view of the novel components of the device 12. However, such translating components to translate bread 31 into and out of the slots 12 upon cessation of toasting are well known mechanical configurations to those skilled in the art and need not be shown.

In FIG. 7 is depicted a particularly preferred mode of the device 10 herein having both a toasting cavity 13 and cooking cavity 16. In this mode the housing 11 has opposing doors 32 formed into the sidewall defining the housing 11 on both sides of the housing 11 which rotate using levers 33. The doors 32 rotate from a vertical to horizontal position using means for rotational engagement such as hinges 36 or pivots. In the horizontal position access is provided to and through, the warming cavity from both sides of the housing 11. This makes it especially easy to insert and remove the tray 15 from either side, and, to be able to season or adjust the food on the tray 15 much better than if only one door 32 were provided since it would be hard to reach the other side of the cooking cavity 16. Additionally, it has been found much easier to insert and remove the tray 15 when both sides are accessible through the apertures 35 formed by the open doors 32.

FIG. 8 shows the mode of the device 10 of FIG. 7 having the doors 32 closed into the apertures 35, closing off the cooking cavity 16. Also shown are bread 31 products within the toasting slot 12 which has the noted conventional mechanical components adapted to descend the bread 31 into the toasting cavity 13 within the housing 11.

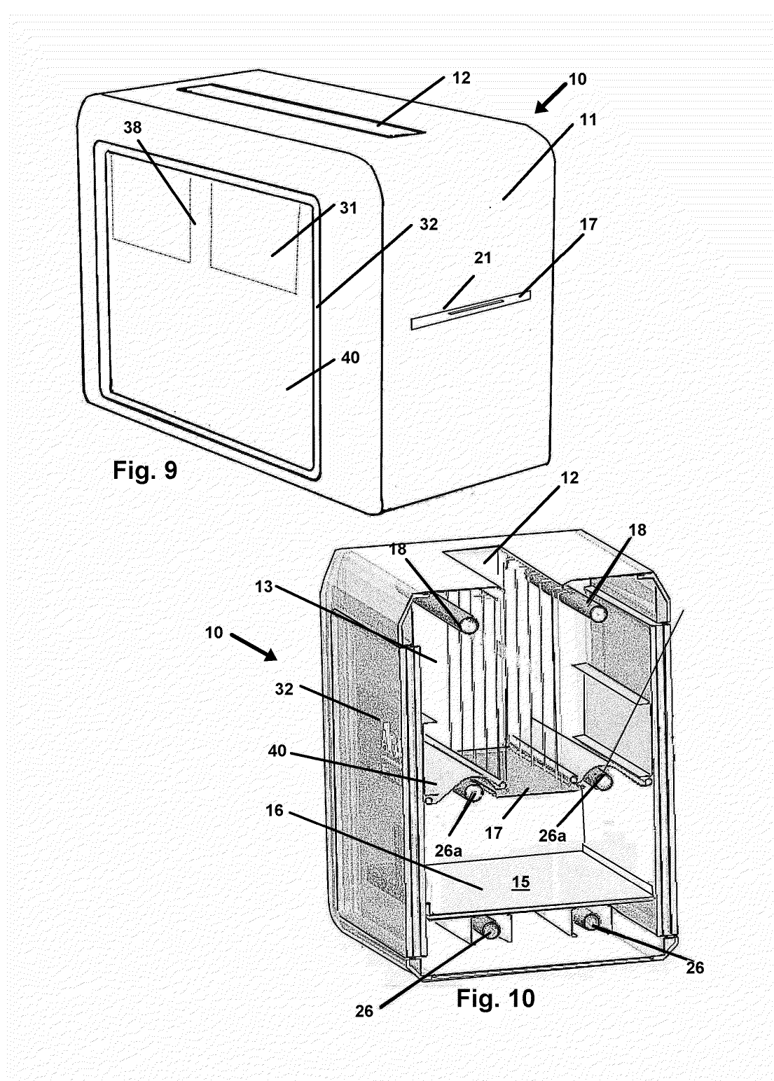

Shown in FIG. 9 is the device 10 of FIG. 8 showing the viewing aperture 38 for bread 31 translated into the toasting cavity 13 while cooking and also for any food on the tray 15 in the cooking cavity 16. This is especially preferred to allow the user to monitor browning of the bread 31 or food, and is provided by glass 40 forming a portion of the doors 32 at least in the upper portion which is adjacent to upper end of the housing 11 where the slot 12 is located.

FIG. 10 is a sectional view of the device of FIGS. 7-9 showing the toasting cavity separated from the cooking cavity 16 within the housing 11 and heating elements 26 and 26a provided by quartz or other heating elements. In this mode, the heating elements 26 are positioned below the position of the tray 15 when engaged within the cooking cavity 16, and secondary heating elements 26a are positioned above the engaged tray 15 which slides into a track or on a wire shelf supporting it in an engaged position in the heating cavity 16. It has been found that surrounding the tray 15 with heating elements on both the upper and lower sides, yields quicker more even cooking.

Also shown in FIG. 10 are curved separators 40 on opposite sides of the crumb tray 17 which is adapted to translate into and out of the housing 11 through the slot 21 shown in FIG. 9. This arrangement or curved separators with the planar crumb tray 17 forming the separating wall between the toasting cavity 13 and the cooking cavity 16 has in experimentation worked especially well. The curved separators 40 act as a lens to focus heat from the heating elements 26a toward the tray 15 surface and combining those with the crumb tray 17 to form the separating wall lessens the weight of the device 10 from that of using a formed wall.

The crumb tray 17 as noted is configured to slide into the housing 11 through the slot 21 therein, on a track which may be formed into the side edges of the curved separators 40.

As such, the device 10 herein provides both vertical toasting as well as a horizontally disposed cooking cavity 16 to users in a small footprint. The cooking cavity 16 is provided especially easy access by the provision of pivoting doors 32 such that the entire surface of the tray 15 is accessible and the tray 15 and food on it may be inserted or removed from either side, and may be guided by two hands during both insertion and removal using the dual apertures provided by the open doors 32.

As noted above, while the present invention has been described herein with reference to particular embodiments thereof and steps in the method of production, a latitude of modifications, various changes and substitutions are intended in the foregoing disclosures, it will be appreciated that in some instance some features or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A toasting appliance, comprising:
a housing, said housing adapted on a first side to sit upon a support surface;
an upper surface of said housing opposite said first side;
at least one slot communicating through said housing on said first side to a toasting cavity;
a cooking cavity located within said housing between said first side and said toasting cavity;
a tray, said tray, said tray translatable from a position outside said housing into a supported position within said cooking cavity, through a tray aperture communicating through a first sidewall of said housing;
at least one first heating element located in said toasting cavity;
at least one secondary heating element located within said cooking cavity; and
said first heating element and said second heating element operatively engageable to an electric power supply, whereby bread products may be positioned withing said toasting cavity and held vertically disposed within said slot for toasting within said toasting cavity, and food may be positioned upon said tray and translated into said cooking cavity in a horizontal disposition for cooking therein.

2. The toasting appliance of claim 1 additionally comprising:
a switch positioned between said electric power supply and said first heating element and said second heating element; and
said switch configured to communicate said electric power supply solely to one of said first heating element and said second heating element, to prevent communication of said electric power to both of said first heating element and said secondary heating element at the same time.

3. The toasting appliance of claim 1 additionally comprising:
a door, said door rotatable from first position vertically inclined and covering said tray aperture to a second position horizontally disposed and exposing said tray aperture; and
said tray translatable between said supported position within said cooking cavity and said position outside said housing while said door is in said second position.

4. The toasting appliance of claim 2 additionally comprising:
a door, said door rotatable from first position vertically inclined and covering said tray aperture to a second position horizontally disposed and exposing said tray aperture; and
said tray translatable between said supported position within said cooking cavity and said position outside said housing while said door is in said second position.

5. The toasting appliance of claim 3 additionally comprising:
at least a portion of said door formed of transparent material; and
said portion of transparent material providing a view of said bread when positioned within said toasting cavity, and said food when positioned within said cooking cavity, whereby a user may monitor the progress of said toasting of said bread or said cooking of said food, visually.

6. The toasting appliance of claim 4 additionally comprising:
at least a portion of said door formed of transparent material; and
said portion of transparent material providing a view of said bread when positioned within said toasting cavity, and said food when positioned within said cooking cavity, whereby a user may monitor the progress of said toasting of said bread or said cooking of said food, visually.

7. The toasting appliance of claim 3 additionally comprising:
a second tray aperture communicating through a second sidewall of said housing, opposite said first sidewall;
a second door, said second door rotatable from a respective first position vertically inclined and covering said second tray aperture to a respective second position horizontally disposed and exposing said second tray aperture; and
said tray translatable between said supported position within said cooking cavity, and said position outside said housing, through either said first tray aperture or said second tray aperture; and
a top surface of said tray accessible by said user through either of said first tray aperture or said second tray aperture, whereby said food whereby a user may adjust or season said food through either said first tray aperture or said second dray aperture and may use two hands to translate said tray to said supported position.

8. The toasting appliance of claim 4 additionally comprising:
a second tray aperture communicating through a second sidewall of said housing, opposite said first sidewall;
a second door, said second door rotatable from a respective first position vertically inclined and covering said second tray aperture to a respective second position horizontally disposed and exposing said second tray aperture; and
said tray translatable between said supported position within said cooking cavity, and said position outside said housing, through either said first tray aperture or said second tray aperture; and
a top surface of said tray accessible by said user through either of said first tray aperture or said second tray aperture, whereby said food whereby a user may adjust or season said food through either said first tray aperture or said second dray aperture and may use two hands to translate said tray to said supported position.

9. The toasting appliance of claim 5 additionally comprising:
a second tray aperture communicating through a second sidewall of said housing, opposite said first sidewall;
a second door, said second door rotatable from a respective first position vertically inclined and covering said second tray aperture to a respective second position horizontally disposed and exposing said second tray aperture; and
said tray translatable between said supported position within said cooking cavity, and said position outside said housing, through either said first tray aperture or said second tray aperture;
at least a portion of said second door formed of transparent material; and
said portion of transparent material of said first door and said second door providing a view of said bread when positioned within said toasting cavity, and of said food when positioned within said cooking cavity, whereby a user may monitor the progress of said toasting of said bread or said cooking of said food, visually through either transparent section positioned in either said first door or said second door.
